(19) United States
(12) Patent Application Publication
(10) Pub. No.: US 2005/0060384 A1
(43) Pub. Date: Mar. 17, 2005

(54) Providing hyperlinks in web documents linkable to other alternative web documents in a world wide web network

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Leslie Van Leeuwen;Intellectual Property Law Department, International Business Machines Corporation, 11400 Burnet Road, Internal Zip 4054, Austin, TX, 78758, US

(73) Assignee: International Business Machines Corporation, Armonk, NY (US)

(21) Appl. No.: 10/660,009

(22) Filed: Sep. 11, 2003

(51) Int. Cl. G06F 15/16; G06F 17/21

(52) U.S. Cl. 709/218; 715/501.1

(57) ABSTRACT

A system, method and program to link a user activating a hyperlink in a Web page to alternate Web documents or sites appropriate to the needs of the users and the owners or hosts of the Web sites. An implementation for linking at least one of the hyperlinks in a Web document when activated to access a selectable one of a plurality of alternate Web documents respectively at alternate sites, then for predetermining one of the plurality of alternate Web documents selected to be accessed upon said activation of the hyperlink and then responsive to this determination for accessing the alternate Web document selected to be accessed.

### TECHNICAL FIELD

The present invention relates to computer managed communication networks such as the World Wide Web (Web) and, particularly, to ease of use of interactive computer controlled display interfaces to receive hypertext documents with hyperlinks that interactively link users from such documents to other documents and programs.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct links between pages and other documentation on the Web and a variety of related data sources that were at first text and images, e.g. both JPEG and MPEG, and then evolved into media, i.e. “hypermedia”. Web documents may also include applets and other programming routines. (The term Web documents as used herein is meant to include all such data documents.) This even further exploded the use of the Internet or Web.

A major problem encountered by all Web users is the amount of wasted time that the user spends in misdirection, e.g. the “blind alleys” that the user often traverses in trying to get to an appropriate Web site or Web document. It is clearly in the interest of all businesses and organizations that use the Web to have their customers and clients reach their intended destinations on the Web as expeditiously and quickly as possible.

A significant source of this time waste is in the Web page (the basic document page of the Web) itself. In the case of Web pages, we do not have the situation of a relatively small group of professional designers working out the human factors. Rather, in the era of the Web, anyone and everyone can design a Web page. Pages are frequently designed by developers without usability skills. As a result, Web pages are frequently set up and designed in an eclectic manner. Often Web pages are set up through loose business, professional, social and educational configurations with general trade or public input of Web pages.

The proliferation of hyperlinks into a variety of Web documents of varying reliability presents dilemmas to businesses, educational and governmental institutions interested in the use of the Web for the wide distribution of their work products. On the one hand, it is the primary purpose of the hypertext—HTML concept—to permit the widespread dissemination of information, including media and programming through linked documents. On the other hand, the hyperlinks to Web sites and documents incorporated into Web documents maintained by unskilled hosts may be inappropriate for the purposes of the owners and hosts of the Web sites and documents to which the hyperlinks are linked.

Accordingly, the host of a Web site may determine that an activated hyperlink from a Web document to his site may be inappropriate. However, applying a business principle of never turning a potential customer or client away, there is a need to give Web site hosts such an option. An example of such a situation may be found with secure or private Web sites. Should a user who is not authorized for access to a secure Web site be hyperlinked to the site? It would be desirable for the Web site host to have an alternative so that it would be not be necessary to refuse access and thereby annoy and perhaps alienate a potential customer.

In addition, while most business organizations have been operating effective secure private networks within their organizations in the past, the greatly increasing quantities of capacity and bandwidth on the Web have made it very economically attractive for businesses to use the Web for access to their private, i.e. secure sites and public sites. In this regard, there is a need to effectively route activated hyperlinks to the appropriate public or private sites.

### SUMMARY OF THE PRESENT INVENTION

The present invention provides a system, method and program to link a user activating a hyperlink in a Web age to alternate Web documents or sites appropriate to he needs of the users and the owners or hosts of the Web sites. Accordingly, the present invention comprises the combination of means for linking at least one of the hyperlinks in a Web document when activated to access a selectable one of a plurality of alternate Web documents including media and programming respectively at alternate sites, means for predetermining the one of the plurality of alternate Web documents selected to be accessed upon said activation of said hyperlink, and means responsive to the predetermining means for accessing the alternate Web document selected to be accessed.

The means for predetermining may just be the Web address or IP address of the user; e.g. this IP address may be used to predetermine the selection based upon geographical location of the requesting user's receiving Web station. Of course, the IP address may be used to determine whether the requesting user is authorized for access to a secure Web document or site. The protected site may be a secure or private internal network of the host of the Web site accessed by the hyperlink.

In one application of this invention, the host of the site of the Web documents accessed through the activated hyperlink may be a business organization, the alternate Web documents could include public documents and protected private Web documents; and the means for selecting could include server means associated with the Web site of the host for storing the IP addresses of the host's employees, whereby the private Web documents would be selected for the host's employees.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a Web portion showing how a Web site may be controlled through a server system to route the same activated hyperlink from a Web document at a requesting station to the appropriate alternative Web site:

FIG. 2 is a block diagram of a data processing system including a central processing unit and network connections via a communications adapter that which is capable of functioning both as a display computer for a receiving Web station and as the server for routing the same activated hyperlink from a Web document at a requesting station to the appropriate alternative Web site;

FIG. 3 is an illustrative flowchart describing the setting up of the elements of a program according to the present invention for routing the same activated hyperlink from a Web document at a requesting station to the appropriate alternative Web site; and

FIG. 4 is a flowchart of an illustrative run of the program set up in FIG. 3.

### DETAILED DESCRIPTION OF THE PREFERRED EMBODIMENT

Before going further into the details of specific embodiments, it will be helpful to understand from a more general perspective the various elements and methods that may be related to the present invention. Since the major aspect of the present invention is directed to Web pages transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents are conventionally implemented in HTML language, which is described in detail in the text entitled: Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages.

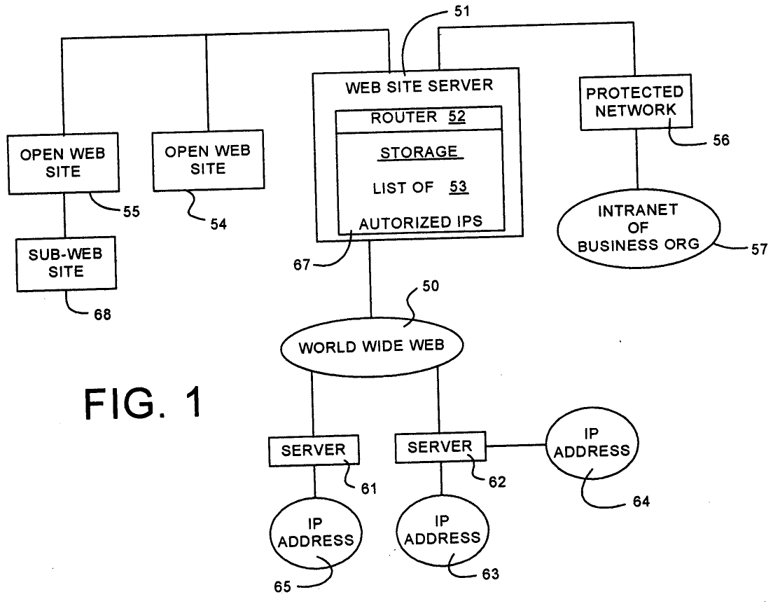

Referring now to FIG. 1, there is provided a generalized view of a network, such as the Web or Internet (used interchangeably herein), showing illustrative Web sites 54 and 55, as well as some IP addresses 63, 64 and 65 representative of receiving display stations from which users may be making requests for access to the Web sites. The open Web sites are connected to the Web communication network through servers such as server 51 to move data to and from the Web 50. Likewise, users at various IP addresses are connected to Web 50 via servers 61 and 62. Accessing Web sites is done using conventional TCP/IP protocols using IP addressing. This is described in detail in the text, Using Networks, Frank J. Derfler, 1998, Que Div. of Macmillan Computer Publishing, Indianapolis, Ind.

Thus, every user originating a request will have an IP address of his receiving display station. For this embodiment, assume that the Web site is a corporate business site, e.g. the International Business Machines Corporation (IBM) site served by server 51. The overall IBM site has open or public Web sites 54, 55 and 68, as well as private or intranet sites 57 secured and protected by network 56. The server 51 has storage means 53, as well as router 52. The storage facility has a list 67 of the IP addresses of all of those who are authorized to have access to the private network 57. Thus, a user at a display station on the Web at any of IP addresses 63 through 65 may select a hyperlink in a Web page that is linked through the Web into server 51 serving the IBM Web site system, both private 57 and public 54, 55 and 68 networks. In the example, let us assume the user has already accessed a publicly available IBM Web page and has pressed on a hyperlink on the page, “IC-Tech”. This hyperlink links to technical support for a particular product. The server 51 program recognizes that the hyperlink is one having two possible alternatives: either the user who activated the link in the general Web page is authenticated to enter the private network 57; or the user must be connected to a public available site 54, 55 or 68. In this example, the technical support available to a member of the general public would, of course, be much less comprehensive and would not contain any organization confidential data. However, the same hyperlink, i.e. the same IP address or URL (Uniform Resource Locator) is used to reach Web server 51. In this simplified example, there may be stored in storage 53, a list, 67, of the authorized IPs of IBM employees, and if the server 51 determines that the hyperlink has been activated from a receiving station 63 through 65 that has an IP on the list 67, then the router 52 routes the requested link through the protected network or firewall to the secured intranet of the business organization 57. If the requesting Web station IP address 63 through 65 is not on the authenticated list, then the server routes the requested link to an appropriate open or public site from which technical data suitable to the general public may be sent. These transactions are completely transparent to the requesting users.

While in the example given the alternate document sources or sites available through the same hyperlink in a Web document have been illustrated with attributes determining private or public information, it is to be understood that other attributes or parameters may be used. In a business organization, alternative information may be made available dependent on the geographical location. For example, consider a central weather bureau database site for the state of Texas. There may be up to four regional Web pages available for east, west, north and south. Thus, when a hyperlink, “Today's Weather”, is activated in a “.gov” Web page for the state, and consequently linked to the appropriate server 51, the location IP of the requester may be determined as to section of the state and the link routed to the site for that section.

In all of the examples given above, the location or IP address of the requesting user has been given as the attribute that determines which of the alternate Web documents will be selected responsive to the activation of the hyperlink. However, other predetermined attributes may be used. Expedients are available for keeping track of the path through the Web that the user has navigated in reaching the document having the hyperlink to alternate Web documents. In the simplest case, if the tracked history indicates that the user has already visited one of the alternate linked documents, it would be logical to link him to one of the Web documents not previously visited. If the tracked data indicates that the user has been navigating through a path of Web documents related to medical information and if one alternative linked documents relates to medicine, while the other relates to the environment, then the data predetermining the choice would be the medical Web path and the user would be linked to the medical Web document.

Other attributes that predetermine which of a plurality of alternative Web pages may be selected by the activation of the same hyperlink may relate to the conditions under which the hyperlink in the Web document is being activated. For example, in the Acrobat program available from Adobe Systems Inc., documents are set up in PDF (Portable Document Format) files viewable on several platforms. The selection between alternate linked Web documents may be determined by the platform of the system on which the Web documents are to be displayed.

In the last described aspects of the invention, the choice of alternate Web documents will be accessed through the same link based upon the Web navigation conditions, etc. This is an HTML implementation like the union type variable in C programming in which a program data structure, the union variable, is interpreted according to how it is used in the program.

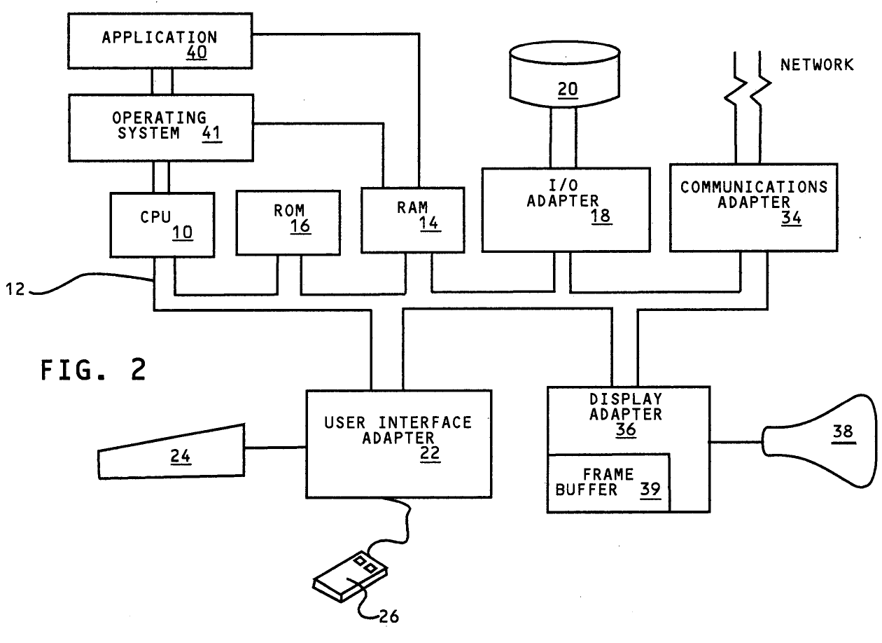

Referring to FIG. 2, a typical data processing terminal is shown that may function as the computer control terminals for Web sites, computer control terminals at requesting user stations or the servers that connect requesting user sites or Web sites into the Web, as well as server 51 of FIG. 1. A central processing unit (CPU) 10, such as one of the workstations or commercial microprocessors in personal computers available from IBM or Dell Corporation; or a workstation, e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems, such as IBM's AIX™ operating systems; Microsoft's Windows XP™ or Windows2000™, as well as UNIX and LINUX operating systems. Application programs 40, controlled by the system, are moved into and out of the main memory Random Access Memory (RAM) 14. These programs include the programs of the present invention operable in server 51 for linking a requesting user who has activated a hyperlink in a Web document to alternate Web or other network documents. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with the outside network, e.g. the Web. The terms, Web or Internet, are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components; such as a digital to analog converter (not shown) and the like. By using the aforementioned I/O devices, a user is capable of inputting information to the system through the keyboard 24 or mouse 26 and receiving output information from the system via display 38 at a receiving Web station.

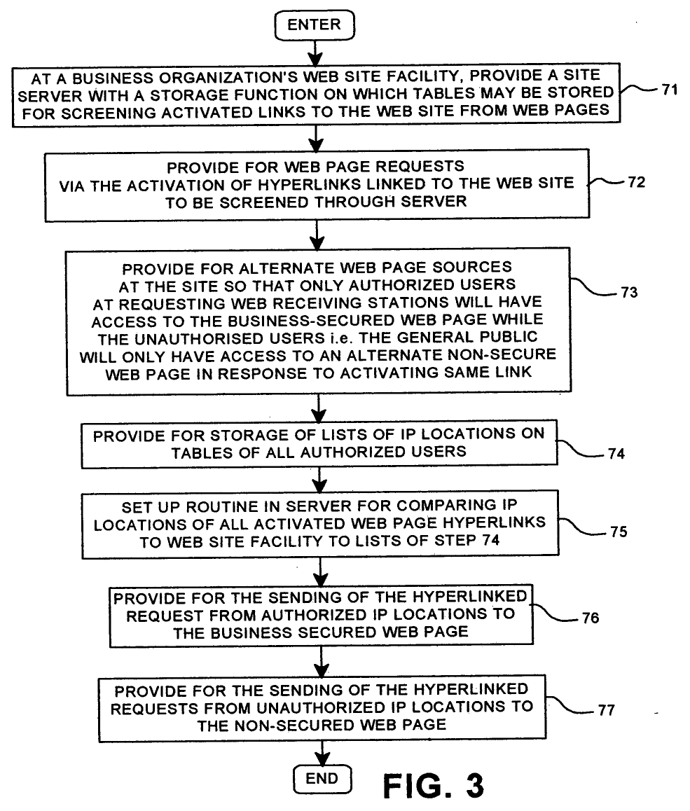

FIG. 3 is a flowchart showing the development of a process according to the present invention for linking a requesting user who has activated a hyperlink in a Web document to alternate Web documents or other network documents.

At an organization's, e.g. business's, Web site facility on the World Wide Web, there is provided a controlling Web site server with an attendant storage function on which data may be stored defining attributes to discern or distinguish between the particular Web receiving stations from which users will activate hyperlinks linked to this Web site facility, step 71. Provision is made for the processing of Web document requests to the Web site facility made from Web receiving stations through the activation of hyperlinks to be sent via the Web to the Web site server, step 72. There is provision for a plurality of alternate Web document sources at the Web site so that only authorized users will have access to the business-secured Web documents while the unauthorized users, the general public, will only have access to an alternate non-secure Web documents in response to these different types of users activating the same hyperlink in a hypertext Web document, step 73. It is to be noted that this example uses the attributes of being authorized or not authorized. As set forth above, other parameters or attributes may be used to route the same hyperlink to different Web sites or documents. Storage is provided for lists of IP addresses of all authorized users, step 74. A routine is set up, step 75, in the server for comparing the stored IP addresses of any activated hyperlink to the site facility to the list stored in step 74. Provision is made for sending a signal indicative of the activation of an alternate hyperlink via the server to the business secured Web document source is the IP address of the station where hyperlink was activated compares as authorized in step 76. Alternately, provision is made for the sending of activated hyperlink requests from unauthorized IP locations to non-secured Web page sources, step 77.

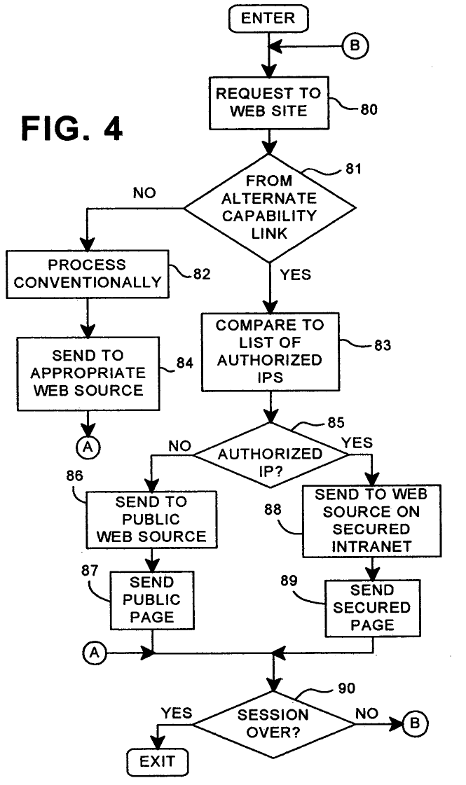

The running of the process set up in FIG. 3 will now be described with respect to the flowchart of FIG. 4. When the Web site facility server receives a request through the activation of a hyperlink, step 80, a determination is first made as to whether the activated hyperlink is one set up to have alternate linking capability, step 81. If No, the request is processed conventionally, step 82, and sent to the appropriate Web document source as the site facility so that the requested hyperlinked document may be sent, step 84. If the determination at step 81 is Yes, the hyperlink has alternate linking, then, following the process of FIG. 3, the IP address of the requesting Web station is compared to a list of authorized IPs stored at the site server, step 83, and a determination is made, step 85, as to authorized IP. If No, the request is sent to an appropriate public Web document source maintained at the Web site, step 86, and the suitable Web document is sent to the requesting user, step 87. If Yes, the IP address is on the authorized IP list, then the hyperlinked request is alternately sent to a Web document source on a secured private intranet, step 88, from which an appropriate document may be sent, step 89. At this point, or after step 87, or step 84 via branch “A”, a determination may conveniently be made as to whether the communication session is over, step 90. If Yes, it is exited. If No, then the session is branched back to step 80 via branch “B”.

One of the preferred implementations of the present invention is in application program 40, i.e. a program made up of programming steps or instructions for determining the alternate destinations of the hyperlinks normally resident in RAM 14, FIG. 2, of the server 51 during various Web operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. In a World Wide Web (Web) communication network with user access via a plurality of data processor controlled interactive receiving display stations for displaying received hypertext Web documents, transmitted from sites on the Web, including at least one display page containing text, images and a plurality of embedded hyperlinks, each hyperlink being user activatable to access and display a respective linked Web hypertext document, a system for linking a user activated hyperlink to alternate Web documents comprising:
means for linking at least one of said hyperlinks when activated to access a selectable one of a plurality of alternate Web documents;
means for predetermining the one of said plurality of alternate Web documents selected to be accessed upon said activation of said hyperlink; and
means responsive to said predetermining means for accessing said alternate Web document selected to be accessed.

2. The Web communication network of claim 1 wherein said means for predetermining further includes means for selecting one of said alternative Web documents based upon the Web (IP) address of the user's receiving display station.

3. The Web communication network of claim 2 wherein:
one of said alternate Web documents includes data protected by the host of the Web document; and
said means for predetermining includes means for determining whether said user is authorized to have access to the protected data.

4. The Web communication network of claim 3 further including an internal network connected to the Web, said alternate Web document including said protected data being from a site on said internal network.

5. The Web communication network of claim 2 wherein said means for selecting one of said alternative documents is selected based upon the geographical location of the user's receiving display station address.

6. The Web communication network of claim 2 wherein said means for selecting one of said alternative documents further includes:
a table of IP addresses;
means for comparing the user's receiving station address to the table; and
means for accessing one of said alternative documents based upon said comparison.

7. The Web communication network of claim 4 wherein
the host of the Web documents is a business organization;
said alternate Web documents include public documents and protected private Web documents; and
said means for selecting includes server means associated with the Web site of said host for storing the IP addresses of the host's employees, whereby said private Web documents are selected for the host's employees.

8. In a World Wide Web (Web) communication network with user access via a plurality of data processor controlled interactive receiving display stations for displaying received hypertext Web documents, transmitted from sites on the Web, including at least one display page containing text, images and a plurality of embedded hyperlinks, each hyperlink being user activatable to access and display a respective linked Web hypertext document, a method for linking a user activated hyperlink to alternate Web documents comprising:
linking at least one of said hyperlinks when activated to access a selectable one of a plurality of alternate Web documents;
predetermining the one of said plurality of alternate Web documents selected to be accessed upon said activation of said hyperlink; and
accessing said alternate Web document selected to be accessed responsive to said predetermination.

9. The method of claim 8 wherein said step of predetermining further includes the step of selecting one of said alternative Web documents based upon the Web (IP) address of the user's receiving display station.

10. The method of claim 9 wherein:
one of said alternate Web documents includes data protected by the host of the Web document; and
said predetermining step includes determining whether said user is authorized to have access to the protected data.

11. The method of claim 10 wherein an internal network is connected to the Web, said alternate Web document including said protected data being from a site on said internal network.

12. The method of claim 9 wherein said means for selecting one of said alternative documents is selected based upon the geographical location of the user's receiving display station address.

13. The method of claim 9 wherein said step of selecting one of said alternative documents further includes:
a table of IP addresses;
comparing the user's receiving station address to a table of IP addresses; and
accessing one of said alternative documents based upon said comparison.

14. The Web communication network of claim 11 wherein
the host of the Web documents is a business organization;
said alternate Web documents include public documents and protected private Web documents; and
said selecting step includes storing the IP addresses of the host's employees, whereby said private Web documents are selected for the host's employees.

15. A computer program having code recorded on a computer readable medium for linking a user activated hyperlink to alternate Web documents in a World Wide Web (Web) communication network with user access via a plurality of data processor controlled interactive receiving display stations for displaying received hypertext Web documents, transmitted from sites on the Web, including at least one display page containing text, images and a plurality of embedded hyperlinks, each hyperlink being user activatable to access and display a respective linked Web hypertext document, said computer program comprising:
means for linking at least one of said hyperlinks when activated to access a selectable one of a plurality of alternate Web documents;
means for predetermining the one of said plurality of alternate Web documents selected to be accessed upon said activation of said hyperlink; and
means responsive to said predetermining means for accessing said alternate Web document selected to be accessed.

16. The computer program of claim 15 wherein said means for predetermining further includes means for selecting one of said alternative Web documents based upon the Web (IP) address of the user's receiving display station.

17. The computer program of claim 16 wherein:
one of said alternate Web documents includes data protected by the host of the Web document; and
said means for predetermining includes means for determining whether said user is authorized to have access to the protected data.

18. The computer program of claim 17 further including an internal network connected to the Web, said alternate Web document including said protected data being from a site on said internal network.

19. The computer program of claim 16 wherein said means for selecting one of said alternative documents is selected based upon the geographical location of the user's receiving display station address.

20. The computer program of claim 16 wherein said means for selecting one of said alternative documents further includes:
a table of IP addresses;
means for comparing the user's receiving station address to the table; and
means for accessing one of said alternative documents based upon said comparison.

21. The Web communication network of claim 1 wherein said means for predetermining further includes means for selecting one of said alternative Web documents based upon the platform of the system of the receiving display station on which the Web documents are to be displayed.

22. The Web communication network of claim 2 wherein one of said alternate Web documents includes a computer program.

23. The method of claim 8 wherein said predetermining step includes selecting one of said alternative Web documents based upon the platform of the system of the receiving display station on which the Web documents are to be displayed.

24. The method of claim 9 wherein one of said alternate Web documents includes a computer program.

25. The computer program of claim 16 wherein one of said alternate Web documents includes a computer program.
